(19) United States
(12) Patent Application Publication
(10) Pub. No.: US 2025/0355027 A1
(43) Pub. Date: Nov. 20, 2025

(54) METERING DEVICE IN AN ELECTRICAL POWER DISTRIBUTION NETWORK

(71) Applicant: SAGEMCOM ENERGY & TELECOM SAS, BOIS-COLOMBES (FR)

(72) Inventor: Henri TEBOULLE, BOIS-COLOMBES (FR)

(21) Appl. No.: 19/210,990

(22) Filed: May 16, 2025

(30) Foreign Application Priority Data
May 16, 2024 (FR) 2405004

(51) Int. Cl. G01R 22/06; G06Q 50/06; H02J 13/00

(52) U.S. Cl. CPC G01R 22/063; G06Q 50/06; H02J 13/00002; H02J 13/00006; H02J 13/00032

(57) ABSTRACT

A meter device for metering information representative of an amount of resource consumed includes a regulating member that can be in one of three states (first state blocking consumption of the resource, second state authorizing consumption up to a first flow rate limit, a third state authorizing consumption of the resource up to a second flow rate limit); verifying whether a credit level is equal to or greater than the amount consumed; and if the verification is negative and the regulating member of the given meter is in the second state, transmitting a message to set the regulating member in the third state, the processor being configured, when the regulating member is in the third state and a flow rate of consumed resource is greater than the second flow rate limit, to change the state of the member from the third state to the first state.

### CROSS-REFERENCE TO RELATED APPLICATIONS

The present application claims priority to French Application No. 2405004 filed with the Intellectual Property Office of France on May 16, 2024, which is incorporated herein by reference in its entirety for all purposes.

### FIELD OF THE INVENTION

The various embodiments described in the present disclosure relate to the management of meters in a distribution network for a prepaid resource, for example a distribution network for electricity, gas, water, heat, etc.

### BACKGROUND OF THE INVENTION

A gateway is available for prepaid energy distribution, centralizing the consumption of one or more meters, and comprising cutting-off the power supply of a meter in the event of credit overruns.

A time delay before a cut-off can be provided to take into account communication problems from a credit recharge to the gateway. Indeed, cut-offs can have harmful consequences.

For example, in the case of an electric meter, cutting off the power supply to safety equipment or a refrigerator the contents of which need to be kept below a maximum temperature threshold can result in danger to people or loss of refrigerated products.

There is a need for a suitable management method for a prepaid resource and the meters of the distribution network for this resource.

### SUMMARY OF THE INVENTION

A first aspect of the present disclosure relates to a resource consumption meter device adapted for a resource distribution network with prepayment, the meter including:
a processor;
a metrological member configured to count the amount of the resource consumed;
a regulating member adapted for being controlled to be in one of three states, including:
   a first state blocking the consumption of the resource;
   a second state authorizing consumption of the resource up to a first flow rate limit; and
   a third state authorizing consumption of the resource up to a second flow rate limit, the second limit being greater than zero and less than the first limit;
a communication interface configured to
   transmit information representative of the amount of the resource consumed; and
   receive a message for controlling the state of the regulating member;

the processor being configured to change the state of the regulating member in response to the message received,

the resource being electricity, the flow rate being a power and the first flow rate limit being a power subscribed to with an electricity supplier, the processor being configured such that, when the regulating member is in the third state and a consumed resource flow rate is greater than the second flow rate limit, the state of the member is changed from the third state to the first state.

According to an embodiment, the information representative of the amount consumed of the resource is transmitted to another device, the message for controlling the state of the regulating member is received from this other device, the other device being one from among a sub-distributor or a data concentrator of the electrical distribution network.

According to one embodiment, the change of state of the regulating member from the third state to the first state is effective
once the second power limit is exceeded by the instantaneous power consumed, or
after a certain period of time spent by the instantaneous power consumed above the second power limit.

A second aspect of the present disclosure relates to a method implemented by a meter device in a distribution network of a prepaid resource, the meter device comprising:
a processor;
a metrological member configured to count the amount of resource consumed;
a regulating member adapted for being controlled to be in one of three states, including:
   a first state blocking the consumption of the resource;
   a second state authorizing consumption of the resource up to a first flow rate limit; and
   a third state authorizing consumption of the resource up to a second flow rate limit, the second limit being greater than zero and less than the first limit;
a communication interface suitable for communicating with a meter management device, the method comprising:
transmitting information representative of the amount of the resource consumed counted by the metrological member to the meter management device;
receiving, from the meter management device, a message for controlling the state of the regulating member;
changing the state of the regulating member in response to the received message, the resource being electricity, the flow rate being a power and the first flow rate limit being a power subscribed to from an electricity supplier, the method further comprising:
when the regulating member is in the third state and a consumed resource flow rate is greater than the second flow rate limit, changing the state of the member from the third state to the first state.

According to an embodiment, the information representative of the amount consumed of the resource is transmitted to another device, the message is received from this other device, the other device being one from among a sub-distributor or a data concentrator of the electrical distribution network.

According to one embodiment, the change of state of the member from the third state to the first state is effective
once the second power limit is exceeded by the instantaneous power consumed, or
after a certain period of time spent by the instantaneous power consumed above the second power limit.

Also disclosed is a computer program product comprising instructions which when executed by at least one processor cause such a method to be implemented.

Also disclosed is a computer-readable storage medium comprising instructions which when executed by a processor cause such a method to be implemented. In one embodiment, the storage medium is non-transitory.

The metering device may comprise software means, that is, instructions intended to be executed by a set of circuits to perform one or more or all of the operations or steps to be carried out by the meter, in application of the methods described in the present disclosure. The set of circuits may comprise dedicated circuitry. It may also comprise one or more processors and one or more memories comprising one or more computer program codes, said processors, memories and computer codes being configured to cause the meter to execute one or more or all of the steps of the methods described in the present disclosure.

### BRIEF DESCRIPTION OF THE FIGURES

The embodiments will be better understood in light of the following detailed description and the accompanying drawings, which are given by way of illustration only and therefore do not limit the present disclosure.

FIG. 1 is a diagram of an example of a network according to one or more exemplary embodiments.

FIG. 2 is a flowchart of a method according to one or more exemplary embodiments.

FIG. 3 is a flowchart of a method according to one or more exemplary embodiments when the resource is electrical energy.

FIG. 4 is a functional block diagram of a device that can be used to implement the methods described.

### DETAILED DESCRIPTION OF THE INVENTION

Various embodiments will now be described in more detail, by way of non-limiting examples, with reference to the drawings accompanying the present disclosure and illustrating certain exemplary embodiments.

The specific structural and functional details disclosed herein are non-limiting examples. The embodiments disclosed here may undergo various modifications and alternative forms. The subject matter of the disclosure may be embodied in many different forms and should not be construed as being limited solely to the embodiments presented herein as illustrative examples. It should be understood that there is no intention to limit the embodiments to the particular forms described in the remainder of this document.

The present disclosure applies to any resource distribution network comprising at least one network head and a plurality of meters measuring the consumption of said resource. For example, this could be a distribution network for electricity, gas, water, heat, etc.

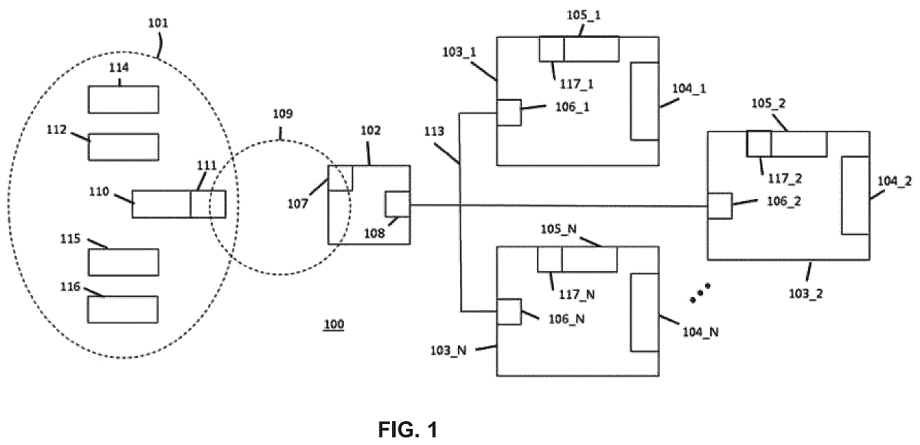

In the non-limiting example shown in FIG. 1, a distribution network 100 includes at least one network head 110 which is configured to communicate via at least one device 102 with a plurality of meters 103_K which are installed on customer premises, where K is an integer from 1 to N, where N is the total number of meters. The device 102 is, for example, a sub-distributor or data concentrator, commonly used in certain power grid architectures.

Communication between the network head 110 and the device 102 can take place in various ways, for example, via a wireless telecommunications network 109. The wireless communication network 109 can be a GPRS, UMTS, LTE, 5G or narrowband IoT (Internet-of-Things) network. The network head 110 and the device 102 are provided with suitable communication interfaces, respectively referenced 111 and 107 in FIG. 1.

The device 102 communicates with meters 103_K. This communication can also take place in various ways, for example, via power line communication (PLC) over an existing cable infrastructure such as the power grid 113. This communication can also take place by other means, especially wireless. The device 102 includes a suitable communication interface 108, while the meters each include a corresponding communication interface 106_K.

A meter 103_K installed on a given customer premises is configured to measure a consumption by each customer of the resource which is distributed via the distribution network 100. For example, when the network 100 is an electricity distribution network, the meter 103_K measures electricity consumption. When the network 100 is a water or gas distribution network, meters can measure the volume of resource consumed. Consumption is measured, for example, using a metrological member 104_K, producing consumption index values.

The meters 103_K connected to the device 102 are configured to transmit customer information representative of consumption to this device, based on the information produced by the metrological member.

This information can be the differences between successive indexes over a given period of time. For example, every day, the meters 103_K transmit information representative of daily consumption. This customer information comprises, for example, a consumption value per time slot of a given duration, for example every 15 minutes. The values transmitted for each 15-minute time slot during the day are used to establish a load curve of a meter for the day.

A brief, non-limiting description of a metrological unit will now be provided. A metrological unit is primarily used to measure, with normative precision requirements, the power demands and the energies (active, reactive, and apparent) typically consumed by the subscriber associated with an electric meter. The metrological unit can also be used to measure other parameters (grid frequency, single-phase and three-phase RMS voltages and RMS currents, voltage phase shifts, total harmonic distortion rates, etc.) and to transmit the energy measurements both to the network operator and to the end customer (typically via a display on the meter itself). Legal metrology refers to the part of metrology that transmits measurements used for billing subscribers.

In practice, several architectures are possible. The main ones are:
(a) A double-microcontroller architecture, with one microcontroller handling legal metrology and the other microcontroller managing the meter's application layer. This structure allows, by maintaining isolation between the two microcontrollers, for the metrological microcontroller to continue measuring and displaying metrological results even if the application microcontroller is out of service (for example, due to a software issue).
(b) A single-microcontroller architecture. In this case, both the metrology software and the application software run on the same microcontroller. This microcontroller can then include a safeguard mechanism enabling the metrology function to continue operating normally even if, for example, the application software is not working properly.

Each meter also includes a regulating member, or regulator, 105_K comprising, inter alia, a regulating component 117_K per se acting directly on the flow rate, for example, a circuit breaker, valve, etc. . . . The state of each regulating member is controlled by the device 102, which transmits control messages to the meters to modify their state. According to the present disclosure, a regulating member has at least three states:
in the first state, no resources can be consumed;
in the second state, the resource can be consumed up to a first flow rate limit;
in the third state, the resource can be consumed up to a second flow rate limit, the second limit being strictly greater than zero and strictly less than the first limit.

For example, according to a non-limiting exemplary embodiment, in the context of an electricity distribution network, the regulating member comprises a circuit breaker or equivalent. The first state thus corresponds to an open circuit-breaker, the second state to a closed circuit-breaker and the third state to a circuit-breaker which is initially closed but is opened when the second power limit is exceeded.

In the third state, the regulating member measures the power consumed and opens the circuit if the second limit is exceeded, either immediately or—in one variant—after a given time above the second limit.

Behavior in the third state is generally similar to that in the second state, but the limits used differ depending on the state.

In the case of networks distributing volumes of resources (water, gas), the regulating member comprises, for example, a valve, which can be open (giving access to a maximum flow) or closed (no resources can be consumed), or in a partially open or closed state, corresponding to the third state mentioned above.

The network head 110 is configured to perform the functions described below, either autonomously or in cooperation with devices or systems with which the network head can communicate. FIG. 1 shows by way of example a communications network 101, for example an IP network such as a VPN or the Internet, of which the network head 110 is part.

According to the non-limiting exemplary embodiment shown in FIG. 1, the network 101 especially comprises a meter data management system 112 (MDMS) server, a payment server 114, a prepayment key management services 115 (KMS) server and a meter key management system 116 (also KMS) server. The functions of these four entities can be grouped together in various ways on one or more common hardware platforms, including with the network head 110. The architecture of FIG. 1 corresponds to a typical architecture, especially due to the separation of key servers from other entities, but other implementations are of course possible.

According to the example shown in FIG. 1, the payment server 114 interacts with customer devices (not shown in FIG. 1) to receive resource credit purchase payments. For each customer, the payment server has access to a key provided by the prepaid key management server 115. This key is also known to the customer device and is used by the customer device to encrypt messages to the payment server. The latter can decrypt a message received from a customer device using the appropriate key. Customer devices include, for example, computers, tablets and cell phones running a suitable application. The meter data server 112 stores each customer's credit level in a memory and, if necessary, updates its data on the basis of messages from the payment server 114 representative of a customer's payment. A customer has an account with the payment server 114, which they can credit.

The credit data will be referred to as C_K hereinafter, where C_K is the level of unused credit for the meter K, that is, the available credit. In the example shown in FIG. 1, credit levels are transmitted by the network head 110, which transmits them to the device 102. The meter key management server 116 stores a key for each meter, the meter keys being communicated by the network head to the device 102.

A key for a meter K is used by the device 102 to exchange information securely with the meter K. A meter that also knows its key can transmit a metrological index of resource consumption to the sub-distributor. The sub-distributor can securely transmit commands to a meter, for example to stop distribution of the resource (opening a power cut-off member, closing a valve for gas or water).

A prepayment key stored by the prepayment key management server 115 enables secure prepayment through a customer device, which is aware of the one or more prepayment keys of the meter associated with the customer account through the application 114.

According to the present disclosure, the regulating member of the distribution of the resource is adapted to allow modulation of the amount of resource accessible per unit of time (flow rate) to an intermediate value between total distribution stoppage and a first flow rate limit, when the associated account balance becomes zero or negative. As previously indicated, the intermediate value is also referred to as the second flow rate limit in the present disclosure.

For an electricity distribution network, the first flow rate limit is, for example, the subscribed power. This subscribed power is typically defined in the subscription contract between the customer and the network operator.

For a water or gas distribution network, the first flow rate limit is, for example, the flow rate corresponding to a fully open valve (maximum flow rate).

The intermediate value, thus the second flow rate limit, can be selected in several ways. For example, it can be a percentage strictly greater than 0% and strictly less than 100% of the first flow rate limit.

For example, the percentage can be chosen such that the intermediate value represents a given fraction of the customer's average consumption. This will allow some uses of the resource, but not all. This has the effect of encouraging the customer to regularize their negative credit situation.

In the case of an electricity network, the power levels to which a customer can subscribe can be defined by a plurality of discrete values, such that the second flow rate limit can correspond to one of these power levels, less than the subscribed power defining the first flow rate limit.

According to one or more embodiments, the customer is warned that the prepaid credit linked to their meter is insufficient to cover the consumption indicated by this meter, i.e. the zero or negative balance. The warning can take the form of an automatically generated text message or e-mail, or a sign on the meter itself. The warning may explicitly indicate the second flow rate limit. This second flow rate limit can also be implicit.

Thus, the customer will know the limit imposed and can manage their use of the resource, for example by giving priority to priority appliances to reduce electricity consumption, limiting gas heating to one room to reduce gas consumption and limiting their use of water to essential uses, thereby remaining below the second flow rate limit.

According to a variant embodiment applicable to an electricity distribution network, when a meter is limited to a power corresponding to the second flow rate limit, the power supply is completely interrupted if consumption exceeds the second flow rate limit.

According to the implementation, this cut-off can be effective as soon as the instantaneous power exceeds the second power limit, or after a certain time above the second power limit. In the latter case, the cut-off member monitors instantaneous power over a predetermined time interval. Instantaneous power is supplied by the metrological member.

According to one or more embodiments, when a meter is limited to the second flow rate limit, the first flow rate limit is restored as soon as the customer has credited the account associated with the meter sufficiently for the balance to be positive again.

In one embodiment, the customer is alerted to the fact that their account has a positive balance, as well as to the fact that the resource is once again available at the nominal flow rate.

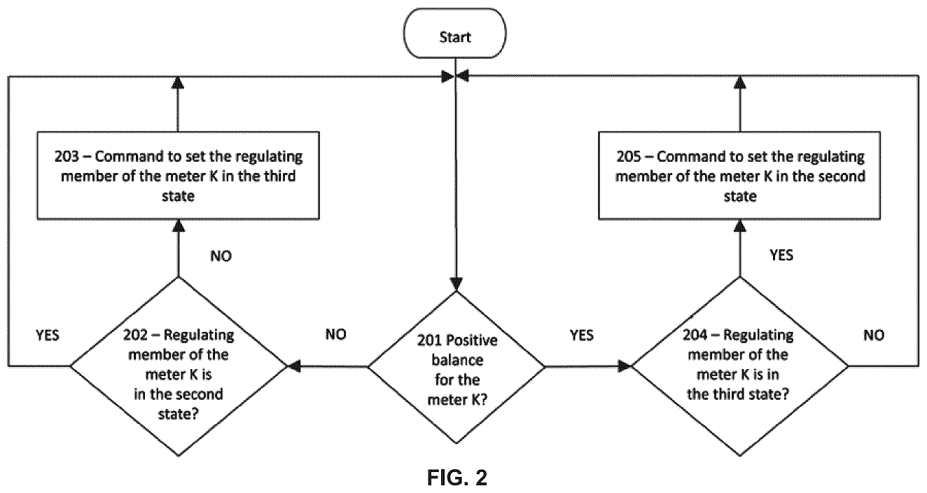

It should be noted that the functionalities of a sub-distributor 102 described in the examples can, in other embodiments, be integrated into the network head 110. Indeed, sub-distributors are generally used in electricity and gas distribution networks, but rarely in water distribution networks. FIG. 2 is a flowchart of a method according to a non-limiting embodiment. The method can be implemented by the device 102, which is ideally placed between the network head and the meters, and can therefore easily control the latter. However, the method can also be implemented by another apparatus of the distribution network. The person skilled in the art will be able to adapt this method to the architecture of the distribution network and the device implementing it.

The device 102 determines (in 201) whether the balance, in other words, the prepaid credit, available for a meter K from which the consumption recorded by this meter is subtracted, is strictly positive or not. The balance indicates whether a customer has consumed exactly what they paid for in advance (zero balance), or whether they have consumed more than they paid for in advance (negative balance).

If the balance is zero or negative, the device 102 will cause the regulating member of the meter to change to the third state. According to the exemplary embodiment of FIG. 2, the device 102 will verify in 202 whether the meter K is in the second state, that is, operating at its nominal flow rate limit (first limit). If this is the case, then a message is transmitted in 203 by the device 102 to the meter K in order for the regulating member of this meter to be set in the third state. This verification of the current state of the regulating member is carried out to avoid sending a message to change to the third state when the regulating member is already in this state.

According to a variant embodiment (not illustrated), the verification in 202 is not carried out and the message in 203 is sent systematically.

The current state is, for example, a state stored by the device 102 during a previous iteration of the method of FIG. 2. Alternatively, this state can be obtained from the relevant meter following a request from the device 102. The method loops back to 201 at the exit from 202 and 203 to verify the balance again, knowing that the customer may have credited their account again in the meantime.

If the balance is positive in 201 and the regulating member is in the third state (positive verification in 204), then the sub-distributor transmits a message to the meter K for the latter to change the state of the regulating member to the second state, once again allowing consumption at the nominal flow rate (circuit breaker closed, valve fully open). Otherwise, the method loops back to once again verify the balance in 201. The situation arises when, once the flow rate has been limited due to a negative or zero balance, a payment is made which allows the balance to become positive again.

A negative balance is possible insofar as a meter does not itself determine whether there is any credit left to consume, but this task is delegated to the device 102, which can receive information relating to the prepaid credit on the one hand and relating to the actual consumption of the resource on the other asynchronously, and thus order a flow limitation when the prepaid credit has already been exceeded.

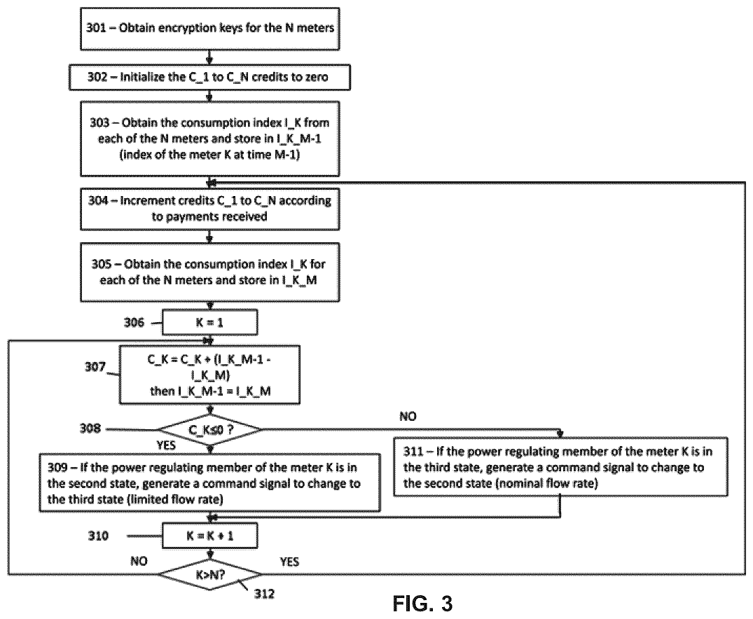

FIG. 3 is a more detailed flowchart of a method according to FIG. 2, with reference to certain elements of FIG. 1.

In 301, the device 102 obtains the encryption keys for N meters 103_1 to 103_N assigned thereto. In 302, the available credits C_1 to C_N associated with each of these meters are initialized to zero. This is seen from the device 102. In 303, the consumption index of each meter at time M-1, I_K_M-1, is obtained from the meters (K varying from 1 to N). The credit available for each meter is incremented according to payments received as communicated in 304 to the device 102 by the network head 110.

Consumption indexes, I_K_M, at time M, more recent than time M-1, are obtained in 305 for the set of meters.

For each meter K:
The available credit C_K is adjusted in 307 by deducting the consumption of the meter K between times M-1 and M—this is the balance.
The consumption index I_K_M is also stored for each meter K, and becomes the index I_K_M-1 for the next iteration.
In 308 it is verified whether or not the balance is less than or equal to 0.
   If this is the case and the power regulating member of the meter K is in the second state (flow rate at the first limit, namely the nominal flow rate), then the device 102 generates in 309 a control message to be sent to the meter K to change the state of the regulating member to the third state (flow rate at the second limit, less than the first limit).
   If this is not the case and the power regulating member of the meter K is in the third state, then the sub-distributor generates in 311 a command message to be sent to the meter K to change the state of the regulating member to the second state.
The index of the meter is incremented to K+1 in 310, and the loop continues until all N meters have been reviewed (verification in 312), after which the method resumes in 304 with the updating of consumption indexes and credits.

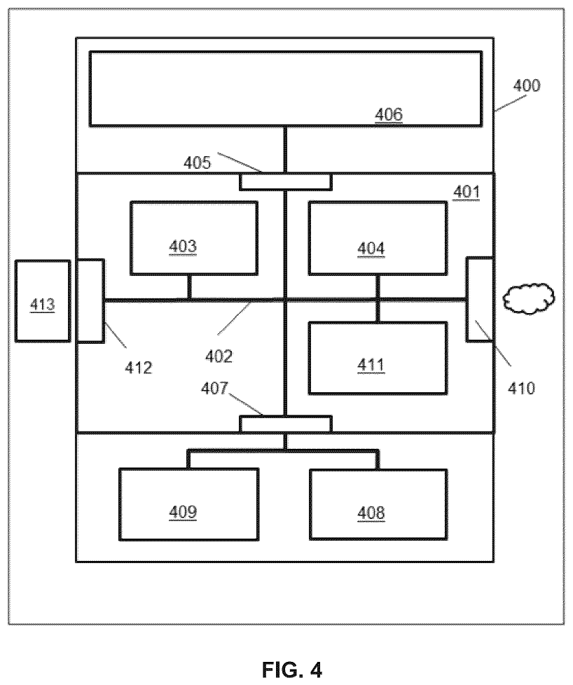

The device implementing the disclosed method can, for example, be implemented in the form of a device as depicted in FIG. 4. The referenced device 400 comprises a printed circuit board 401 on which a communication bus 402 connects a processor 403, a random access memory 404, a storage medium 411, optionally an interface 405 for connecting a display 406, a series of connectors 407 for connecting user interface devices or modules such as a mouse or trackpad 408 and a keyboard 409, one or more wireless network interfaces 410 and/or one or more wired network interface 412. Depending on the functionality required, especially whether the device 400 is being used in a network head 110 or a sub-distributor 102, the device may implement only some of the foregoing. For example, some modules shown in FIG. 4 may be internal or externally connected, in which case they are not necessarily an integral part of the device itself. For example, the display 406 may be a display that is only connected to the device 400 in specific circumstances, or the device 400 may be controlled by another device with a display, in which case the device 400 has no display 406 or interface 405.

The memory 411 contains one or more software codes which, when executed by the processor 403, enable the network head 110 or sub-distributor, according to the implementation, to perform the management method disclosed herein. In one exemplary embodiment, a removable storage medium 413, such as a USB key, can also be connected. For example, the detachable storage medium 413 may contain software codes to be downloaded into the memory 411.

The processor 403 can be any type of processor such as a central processing unit (“CPU”) or a dedicated microprocessor such as an integrated microregulating member or digital signal processor (“DSP”).

The device 400 may also comprise other components typically found in computer systems, such as an operating system, queue managers, device drivers, or one or more network protocols that are stored in the memory 411 and executed by the processor 403.

The device 400 can also be used to implement a meter, integrating a regulating member 105_K and a metrological member 104_K.

According to one embodiment, the regulating member comprises a processor, software code executed by the processor, and a flow rate regulating component 117_K per se (circuit breaker, valve, etc.). Control signals for the flow rate regulating component are generated by the processor when it executes the software. The processor of the regulating member can be the processor 403. The software code can be stored in the memory 411.

Depending on the requirements and the nature of the meter, some components can be removed and others added.

The person skilled in the art will understand that all the block diagrams presented here represent conceptual views, given by way of example, of circuits incorporating the principles of the disclosure.

Each function, block, and step described can be implemented in hardware, software, firmware, middleware, microcode, or any suitable combination thereof. If implemented in software, the functions or blocks of the block diagrams and flowcharts can be implemented by computer program instructions/software codes, which can be stored or transmitted on a computer-readable medium, or loaded onto a general-purpose computer, special-purpose computer, or other programmable processing device and/or system, such that the computer program instructions or software code running on the computer or other programmable processing device create the means for implementing the functions described in this description.

Although aspects of this disclosure have been described with reference to specific achievements, it should be understood that these achievements merely illustrate the principles and applications of this disclosure. It is therefore understood that numerous modifications can be made to the illustrative embodiments and that other arrangements can be devised without departing from the spirit and scope of the disclosure as determined on the basis of the claims and their equivalents.

Advantages and solutions to problems have been described above with regard to specific embodiments of the invention. However, advantages, benefits, solutions to problems, and any element which may cause or result in such advantages, benefits or solutions, or cause such advantages, benefits or solutions to become more pronounced shall not be construed as a critical, required, or essential feature or element of any or all of the claims.

### LIST OF REFERENCE SIGNS

100—Prepaid resource distribution network
101—Communication network
102—Sub-distributor or data concentrator
103_K—resource meter K
104_K—Metrological member of the meter K
105_K—Resource regulating member of the meter K
106_K—Communication interface of the meter i
107—Communication interface of the sub-distributor
108—Communication interface of the sub-distributor
109—Network head—sub-distributor communication network
110—Network head
111—Communication interface of the network head
112—Meter data management system
113—Sub-distributor—meter communication network
114—Prepayment application
115—Prepayment key management system
116—Meter key management system
117_K—Regulating component of meter K
400—Device
401—Printed circuit board
402—Communication bus
403—Processor
404—Random access memory
405—Interface
406—Screen
407—Connectors
408—Mouse
409—Trackpad
410—Wireless interface
411—Storage medium
412—Wired network interface
413—Removable storage medium

1. A resource consumption meter device adapted to a resource distribution network with prepayment, the meter including:
a processor;
a metrological member configured to count the amount of the resource consumed;
a regulating member adapted for being controlled to be in one of three states, including:
a first state blocking the consumption of the resource;
a second state authorizing consumption of the resource up to a first flow rate limit; and
a third state authorizing consumption of the resource up to a second flow rate limit, the second limit being greater than zero and less than the first limit;
a communication interface configured to.
transmit information representative of the consumed amount of the resource; and
receive a message for controlling the state of the regulating member;
the processor being configured to change the state of the regulating member in response to the message received,
the resource being electricity, the flow rate being a power and the first flow rate limit being a power subscribed to with an electricity supplier, the processor being configured such that, when the regulating member is in the third state and a consumed resource flow rate is greater than the second flow rate limit, the state of the member is changed from the third state to the first state.

2. The device according to claim 1, wherein the information representative of the consumed amount of the resource is transmitted to another device, the message for controlling the state of the regulating member is received from this other device, the other device being one from among a sub-distributor or a data concentrator of the electrical distribution network.

3. The device according to claim 1, the change of state of the member from the third state to the first state is effective
once the second power limit is exceeded by the instantaneous power consumed, or
after a certain period of time spent by the instantaneous power consumed above the second power limit.

4. A method implemented by a metering device in a distribution network of a prepaid resource, the metering device comprising:
a processor;
a metrological member configured to count the amount of the resource consumed;
a regulating member adapted for being controlled to be in one of three states, including:
a first state blocking the consumption of the resource;
a second state authorizing consumption of the resource up to a first flow rate limit; and
a third state authorizing consumption of the resource up to a second flow rate limit, the second limit being greater than zero and less than the first limit;
a communication interface suitable for communicating with a meter management device, the method comprising:
transmitting information representative of the consumed amount of the resource counted by the metrological member to the meter management device;
receiving, from the meter management device, a message for controlling the state of the regulating member;
changing the state of the regulating member in response to the received message, the resource being electricity, the flow rate being a power and the first flow rate limit being a power subscribed to from an electricity supplier, the method further comprising:
when the regulating member is in the third state and a consumed resource flow rate is greater than the second flow rate limit, changing the state of the member from the third state to the first state.

5. The method according to claim 4, wherein the information representative of the consumed amount of the resource is transmitted to another device, the message is received from this other device, the other device being one from among a sub-distributor or a data concentrator of the electrical distribution network.

6. The method according to claim 4, the change of state of the member from the third state to the first state is effective
once the second power limit is exceeded by the instantaneous power consumed, or
after a certain period of time passed by the instantaneous power consumed above the second power limit.

7. A non-transitory computer-readable storage medium comprising instructions which when executed by a processor cause the implementation of the method according to claim 4.
